(19) United States
(12) Patent Application Publication
(10) Pub. No.: US 2008/0233210 A1
(43) Pub. Date: Sep. 25, 2008

(54) Co-Biocidal Formulation for Polymeric Materials

(75) Inventors: Mark J. Manning, Santa Monica, CA (US); Marek J. Gnatowski, Coquitlam (CA)

Correspondence Address: SHERIDAN ROSS PC, 1560 BROADWAY, SUITE 1200, DENVER, CO, 80202, US

(73) Assignee: U.S. BORAX INC., Englewood, CO (US)

(21) Appl. No.: 11/915,109

(22) PCT Filed: Nov. 30, 2006
(86) PCT No.: PCT/US2006/019821

§ 371 Date: Apr. 30, 2008

Related U.S. Application Data
(60) Provisional application No. 60/683,700, filed on May 22, 2005.

(51) Int. Cl. A01N 59/14; A01P 3/00

(52) U.S. Cl. 424/660

(57) ABSTRACT

Polymeric materials containing at least one continuous phase man-made polymer and at least one biodegradable component are protected against microbial attack through the use a combination of a boron-containing compound and an organic biocide. Methods and compositions for preparing treated polymeric materials are provided. A shaped article comprising a continuous phase man-made thermoplastic resin polymer, a biodegradable component, a boron-containing compound and an organic biocide is also provided.

This application claims the benefit of provisional application No. 60/683,700, filed May 22, 2005, the entire content of which is incorporated herein by reference. This invention relates to the protection of polymeric materials against microbial attack through the use a combination of a boron-containing compound and an organic biocide.

### BACKGROUND

The majority of pure polymeric materials are relatively resistant to biological attack. However, under suitable conditions, microbial growth, such as fungi, algae and bacteria, can be observed on polymeric materials. While fungi type microorganisms seem to be predominant in colonizing the surface of such materials, algae growth has also been observed in some situations. Frequently, the source of food supporting this growth is non-polymeric additives or components, polymer monomers, other material additives, by-products of environmental degradation, foreign contaminants trapped on the plastic surface, etc. Only certain polymers, such as for example cellulose or cellulose derivatives, aliphatic polyesters (for example polycaprolactone and polylactide), and certain polyurethanes, seem to be susceptible to direct microbial attack and degradation of the main polymer chain. As used herein, the term polymeric materials applies to all man-made materials where the polymer acts as a binder creating a continuous phase. Other materials could be introduced within this continuous phase such as, for example, particles of other polymers or organic matter including natural products, minerals or metals, gases or liquids. Plastics, rubbers, coatings, sealants and adhesives are all examples of polymeric materials.

Fungal growth on polymeric materials can cause a loss of material properties such as flexural strength, tensile strength or elongation at break, loss of surface integrity, significant discoloration, odor or unpleasant appearance. The development of a new generation of environmentally friendly materials, such as for example plastic filled with wood, with increased susceptibility to fungal attack creates a strong need for better protection of such materials. These polymeric materials that are sensitive to fungal attack require a more efficient, environmentally friendly and cost effective biocidal system. Furthermore, fungi, algae and/or bacteria growth on such materials presents aesthetic problems and can create slick, unsafe surfaces where these materials are used in walking surfaces.

To protect polymeric materials against fungal attack, the addition of biologically active compounds (fungicides) is required. In the case of thermoplastic resin, the fungicide must be compatible with all ingredients of the resin system and thermally stable at typical processing temperatures. Furthermore, it should be cost effective, non-toxic, easy to handle and store, safe for the environment, and it should not give an undesirable color or odor to the thermoplastic resin product.

Organic fungicides are usually very expensive and can be toxic to the environment and sometimes to some degree to humans. Addition levels up to 10% in the polymer matrix may be required to control fungal growth in some situations, depending on the product, product service conditions, and required protection level. In situations where a significant amount of fungi degradable component is present, the typical quantity of biocide may not always be sufficient.

Some polymeric materials, such as sealants and the majority of paints, can be processed at moderate temperatures. However, other polymeric materials require processing at elevated temperatures, sometimes approaching or exceeding 400° F. Such processing requirements make the selection of fungicides a difficult task, as the temperature stability of the fungicide must also be considered.

Furthermore, many polymeric materials are intended for service in exterior conditions where direct exposure to water or ultraviolet light must be expected. This makes selection of fungicides even more difficult. Generally, in such exterior conditions, fungicides with a higher level of resistance to degradation by ultraviolet (UV) light are required which significantly increases the cost of protection of the polymeric materials against fungal attack. Formulations designed and optimized for use in protected environments are frequently not fully effective for exterior use.

### SUMMARY OF THE INVENTION

In one aspect, the invention provides a method for protecting a polymeric material against microbial attack, wherein the polymeric material is comprised of at least one continuous phase man-made polymer and at least one biodegradable component, and wherein the method comprises incorporating into the polymeric material at least one boron-containing compound and at least one organic biocide, thereby producing a treated polymeric material.

In another aspect, the invention provides a treated polymeric material comprising a continuous phase man-made polymer, a biodegradable component, a boron-containing compound and an organic biocide.

In another aspect, the invention provides a shaped article comprising a continuous phase man-made thermoplastic resin polymer, a biodegradable component, a boron-containing compound and an organic biocide.

### DETAILED DESCRIPTION OF THE INVENTION

This invention provides methods and compositions for protecting polymeric materials against microbial attack from organisms such as fungi and algae, through the use of a synergistic co-biocidal combination of an organic biocide and a borate or boron-containing compound. The organic biocide can be a fungicide for protection against fungi, an algicide for protection against algae, a bactericide for protection against bacteria, or a combination thereof. The co-biocidal combination provides efficient, cost effective, and environmentally friendly protection to the polymeric materials. The polymeric materials treated according to the invention include man-made materials where a polymer acts as a binder creating a continuous phase. Such man-made polymeric materials can belong to a variety of polymer types including, for example, polyolefins (polyethylenes or polypropylenes), polyvinylchloride, polyurethanes, polyesters, acrylics or vinyl acetate, styrenic resins, or polyisoprenes. A blend of these polymers may be used as well.

The addition of borates to polymeric materials can significantly reduce the amount of organic biocide which is needed for control of microbial growth. Furthermore, the combination of organic biocide with borate can provide better resistance against weathering than organic biocide or boron compound alone. The organic fungicides and algicides used for plastics or other polymeric materials are typically very expensive and the cost of such biocidal additives, when used alone for control of microbial growth, may significantly increase the cost of the final product. By comparison, borates, including zinc borate, are relatively inexpensive and this combination with an organic fungicide tends to be significantly less costly. In some cases, better control of microbial growth may be achieved at a lower overall cost using a combination of borate with an organic biocide. Furthermore, in addition to biological control, borates and other boron-containing compounds, when combined with organic biocides, can also provide improved fire retardancy and/or anti-corrosion properties. The addition of zinc borate to polymeric materials containing HALS (hindered amine light stabilizers) should also improve resistance against weathering. Zinc borate has the added advantage over other, more rapidly soluble boron compounds, of providing a decrease in borate leaching in exterior conditions. Zinc and zinc borate can also be quickly and accurately assayed in the polymeric material using x-ray fluorescence spectroscopy. This is particularly useful for quality control during manufacturing, when the production of high quality products is a concern.

In addition, borates are relatively safe for humans, compared to organic biocides. Therefore, the synergistic composition of borates and organic biocides provided by the invention present less risk to people and the environment due to the lower quantity of organic biocides used, when compared with organic biocides used alone for microbial control in plastics or other polymeric materials.

Furthermore, it has also been found that the presence of anti-oxidants and/or UV stabilizer systems such as HALS, possibly combined with a UV light absorbing compound, may further reduce the microbiological susceptibility of the materials described above that contain borate and organic antimicrobial additives.

A wide variety of man-made polymeric materials can be treated according to the methods and compositions of this invention. The polymers which may be present in such polymeric materials include, for example: polyolefins such as polyethylene, polypropylene, and copolymers based on olefinic based monomers; polystyrene, and polystyrene copolymers including butadiene, acrylate etc.; polymers containing halogen such as polychloroprene, chlorinated rubbers, polyvinyl chloride, polyvinilidene chloride, a variety of copolymers etc.; polyacrylates and polymethacrylates, acrylate or methacrylate copolymer, polyacryloamides, polyacriloimides etc.; polymers derived from unsaturated alcohols and amines or the acyl derivatives or acetals thereof, for example polyvinyl acetate; homopolymers or polymers of cyclic ethers such as polyethylene oxide; polyacetals, for example polyoxymethyline; polyurethanes and polyureas; polyamides, for example nylon 12 or nylon 6; saturated and cured unsaturated polyesters, for example polyethylenetherephthalate; polycarbonates and other aromatic polyesters; crosslinked polymers obtained by condensation of phenols, ureas, or melamines with aldehydes; epoxy resins cured with polyphenol amines, anhydrides or by ring opening polymerization; and polymers obtained by dienemonomer polymerization, for example polybutadiene, polyisoprene. Polymer blends can also be protected by the biocidal composition described in the invention. Suitable polymers can be used in many forms for manufacturing polymeric materials. Such forms include thermoplastic resins, chemocurable resins, thermocurable resins, their emulsions and solutions in suitable solvents.

A common reason that polymeric materials require biocidal protection is the presence in the such materials of biodegradable additives or components. Such biodegradable components are often subject to degradation by fungi. Examples of biodegradable components or additives found in polymeric materials which can be protected using the methods of the invention include wood, bark, fatty oils or their derivatives, cellulose or modified cellulose derivative, aliphatic polyesters or their mixture, or fatty acids or their derivatives, chitin or chitosin or their derivatives. Such biodegradable components include:
natural products such as wood, bark, cellulosic fiber, fatty oils plant or animal origin, fatty acids, sugars, etc., polyhydroxyvalerate and/or polyhydroxybutyrate;
modified natural products such as starch, cellulose, epoxidized fatty oils, prepolymerized fatty oils; and
synthetic biodegradable materials such as certain surfactants, synthetic oils, ester type plasticizers, man-made polymers such as polycaprolactones or polylactides.

Typical levels (in weight percent) of such biodegradable additives or components in polymeric materials vary widely. For example:
wood or bark may be present in quantities of 20% to 90% by weight, but are frequently in the range of 40% to 75%;
fatty oils and their derivatives may be present in quantities of 1% to 96% by weight, but are frequently in the range of 30% to 70%;
polysaccharides may be present in quantities of 0.3% to 95% by weight, but are frequently in the range of 1% to 75%;
fatty acids or their salts may be present in quantities of 0.3% to 30% by weight, but are frequently in the range of 1% to 10%; and
aliphatic polyesters may be present in quantities of 1% to 95% by weight, but are frequently in the range of 2% to 50%.

Suitable boron-containing compounds for use in the methods and compositions of the invention include a variety of borates, such as boric oxide, boric acid, and salts of boric acid, e.g. sodium borates, calcium borates and zinc borates, and mixtures thereof. One example of a desirable boron-containing compound which can be used in the methods and compositions of the invention is zinc borate. The boron-containing compounds can be added in quantities as low as 0.2% by weight and up to 5% based on the weight of the treated polymeric material, or preferably in the range of 0.5% to 3% by weight. The boron-containing compounds can be incorporated into polymeric materials during the manufacturing process. The boron-containing compounds may be added to the polymer binder matrix by any conventional method. They can be added in various forms, such as borate powders or as a solution.

The synergistic effect of organic fungicide in a mixture with borates can be obtained using fungicides such as: 4.5-dichloro-2-n-octyl-4-isothiazolin-3-one, N-(trichloromethylthio) phthalimide, Pyrithione zinc, Tetrachloroisophthalonitrile, etc. Other organic fungicides which can be used in combination with borates in the polymer materials of the invention include certain organosulphur compounds, e.g. methylenedithiocyanate, isothiazolones or dimethyl tetrahydro-1,3,5,-2H-thiodiazine-2-thione; chlorinated phenols, e.g. sodium pentachlorophentolate or 4,4′-dichloro-2-hydroxydiphenyl ether; trioganotin compounds, e.g. bis-tributyltin oxide; and 2-thiazol-4-yl-1H-benzoimidazole. A mixture of organic fungicides could also be used.

Suitable levels of certain organic fungicides for use according to the invention (expressed as a weight percent of the treated polymeric material) include, for example:
4.5 dichloro-2-n-octyl-4-isothiazolin-3-one in concentrations of 0.005% to 0.3%, or preferably 0.01% to 0.2%
N-(triclhlormethylthio)-phthalimide in concentrations of 0.03% to 1.0%, or preferably 0.05% to 0.5%
Pyrithione zinc in concentrations of 0.01% to 1.0%, or preferably 0.5% to 0.03%
Tetrachloroisophthalonitrile in concentrations of 0.1% to 1.0%, or preferably 0.2% to 0.75%.
2 thiazol-4-yl-1H-benzoimidazole in concentrations of 1% to 0.005%, or preferably 0.5% to 0.1%

A suitable algicide for use in the invention would be N-cyclopropyl N′-(1,1-dimethylethyl)-6-(methylthio)-1,3,5-triazind-2,4-diamine, available commercially as IRGAROL® 1051 from Ciba Specialty Chemicals Canada Inc. A suitable bactericide for use in the invention would be 2((hydroxymethyl)amino)ethanol, available commercially as TROYSAN® 174 from Troy Chemical Corp.

Organic biocides can be introduced in many suitable ways, for example directly or in the form of concentrates precompounded (pre-mixed) for example with the desired polymeric material (masterbatches), to avoid problems associated with dusting of the biocide during production of the final polymeric product. This method may be used, for example, with rubbers and plastics, as well as with paints, sealants and adhesives. In the case of manufacturing of paints, sealants or adhesives, preweighed biocide powders packed in water, or solvent carrier media, soluble plastic bags could be used. The use of masterbatches as a source of additives to avoid dusting is very popular in plastics manufacturing and can be applied to the invention. Organic biocides used in extrusion or other applications involving thermoplastic materials can also be precompounded with thermoplastic resin prior to entering the manufacturing process. Organic biocides can be precompounded with plastics in quantities of 0.1-75%, preferably 3 to 45%, and more preferably 5 to 20%, for subsequent addition to thermoplastic resin in the extrusion process. Borates and other components of the final polymeric material can also be added as part of a masterbatch.

The invention can be further explained in the following examples:

### EXAMPLES

### Polymeric Boards

### Example 1

Polymeric board material made from a mixture of thermoplastic resin and wood composite boards were extruded using material composition as shown in Table 1. Composition contained Polyethylene, a masterbatch of biocidal active ingredient mixed with thermoplastic resins as shown in Table 1, Pine or Oak wood flours, lubricant package, talc, and zinc borate or boric acid. Optionally selected formulations contained a UV stabilizer package. The extruder used was a Cincinnati Milicron E-55 with 55 mm conical counter-rotating screws equipped with five heating zones. The temperature of all five zones was set up at 345° F. A Strandex patented die was used to ensure wood fibre orientation. Extruded boards 150 mm in width and 25 mm in thickness were cooled on the line by sprayed cold water. Boards containing approximately 65% wood were used for evaluation of fungi resistance.

TABLE 1

| | | | | parts | | parts | parts | | | | | |
|---|---|---|---|---|---|---|---|---|---|---|---|---|
| Expt. | Wood | Parts | parts | UV | parts | Zinc | EBS | Masterbatch | | | Zinc Borate | |
| No. | Type | Wood | HDPE | Package | Talc | Stearate | Wax | Type | Parts | % ai | Parts | % ai |
| 101 | Pine | 13262 | 5164 | 574 | 200 | 400 | 200 | none | 0 | 0 | 200 | 1 |
| 102 | Pine | 9947 | 4304 | 0 | 150 | 300 | 150 | none | 0 | 0 | 150 | 1 |
| 103 | Pine | 13122 | 5098 | 580 | 200 | 400 | 200 | none | 0 | 0 | 400 | 2 |
| 104 | Pine | 9842 | 4258 | 0 | 150 | 300 | 150 | none | 0 | 0 | 300 | 2 |
| 105 | Pine | 13402 | 5228 | 570 | 200 | 400 | 200 | none | 0 | 0 | 0 | 0 |
| 106 | Pine | 10051 | 4349 | 0 | 150 | 300 | 150 | none | 0 | 0 | 0 | 0 |
| 107 | Pine | 9842 | 4258 | 0 | 150 | 300 | 150 | A | 300 | 0.2 | 0 | 0 |
| 108 | Pine | 9926 | 4294 | 0 | 150 | 300 | 150 | A | 180 | 0.12 | 0 | 0 |
| 109 | Pine | 9973 | 4315 | 0 | 150 | 300 | 150 | A | 112 | 0.075 | 0 | 0 |
| 110 | Pine | 9999 | 4326 | 0 | 150 | 300 | 150 | A | 75 | 0.05 | 0 | 0 |
| 111 | Pine | 10020 | 4335 | 0 | 150 | 300 | 150 | A | 45 | 0.03 | 0 | 0 |
| 112 | Pine | 9894 | 4281 | 0 | 150 | 300 | 150 | A | 75 | 0.05 | 150 | 1 |
| 113 | Pine | 9789 | 4236 | 0 | 150 | 300 | 150 | A | 75 | 0.05 | 300 | 2 |
| 114 | Pine | 9915 | 4290 | 0 | 150 | 300 | 150 | A | 45 | 0.03 | 150 | 1 |
| 115 | Pine | 9810 | 4245 | 0 | 150 | 300 | 150 | A | 45 | 0.03 | 300 | 2 |
| 116 | Pine | 9894 | 3828 | 453 | 150 | 300 | 150 | A | 75 | 0.05 | 150 | 1 |
| 117 | Pine | 13262 | 5738 | 0 | 200 | 400 | 200 | B | 200 | 0.13 | 0 | 0 |
| 118 | Pine | 13297 | 5753 | 0 | 200 | 400 | 200 | B | 150 | 0.1 | 0 | 0 |
| 119 | Pine | 9999 | 4326 | 0 | 150 | 300 | 150 | B | 75 | 0.05 | 0 | 0 |
| 120 | Pine | 9894 | 4281 | 0 | 150 | 300 | 150 | B | 75 | 0.05 | 150 | 1 |
| 121 | Pine | 9789 | 3810 | 426 | 150 | 300 | 150 | B | 75 | 0.05 | 300 | 2 |
| 122 | Pine | 9920 | 4292 | 0 | 150 | 300 | 150 | B | 38 | 0.025 | 150 | 1 |
| 123 | Pine | 9816 | 4247 | 0 | 150 | 300 | 150 | B | 37 | 0.025 | 300 | 2 |
| 124 | Pine | 9894 | 3855 | 426 | 150 | 300 | 150 | B | 75 | 0.05 | 150 | 1 |
| 125 | Pine | 13297 | 5153 | 0 | 200 | 400 | 200 | C | 750 | 0.5 | 0 | 0 |
| 127 | Pine | 10009 | 4091 | 0 | 150 | 300 | 150 | C | 300 | 0.2 | 0 | 0 |
| 128 | Pine | 10030 | 4220 | 0 | 150 | 300 | 150 | C | 150 | 0.1 | 0 | 0 |
| 129 | Pine | 9905 | 4045 | 0 | 150 | 300 | 150 | C | 300 | 0.2 | 150 | 1 |
| 130 | Pine | 9800 | 4000 | 0 | 150 | 300 | 150 | C | 300 | 0.2 | 300 | 2 |
| 131 | Pine | 9926 | 4174 | 0 | 150 | 300 | 150 | C | 150 | 0.1 | 150 | 1 |
| 132 | Pine | 9821 | 4129 | 0 | 150 | 300 | 150 | C | 150 | 0.1 | 300 | 2 |
| 133 | Pine | 9800 | 3572 | 428 | 150 | 300 | 150 | C | 300 | 0.2 | 300 | 2 |
| 134 | Oak | 9947 | 4304 | 0 | 150 | 300 | 150 | none | 0 | 0 | 150 | 1 |
| 135 | Oak | 9842 | 4258 | 0 | 150 | 300 | 150 | none | 0 | 0 | 300 | 2 |
| 136 | Oak | 10051 | 4349 | 0 | 150 | 300 | 150 | none | 0 | 0 | 0 | 0 |
| 137 | Oak | 9999 | 4326 | 0 | 150 | 300 | 150 | A | 75 | 0.05 | 0 | 0 |
| 138 | Oak | 9894 | 4281 | 0 | 150 | 300 | 150 | A | 75 | 0.05 | 150 | 1 |
| 139 | Oak | 9999 | 4326 | 0 | 150 | 300 | 150 | B | 75 | 0.05 | 0 | 0 |
| 140 | Oak | 9894 | 4281 | 0 | 150 | 300 | 150 | B | 75 | 0.05 | 150 | 1 |
| 141 | Oak | 10009 | 4091 | 0 | 150 | 300 | 150 | C | 300 | 0.2 | 0 | 0 |
| 142 | Oak | 9905 | 4045 | 0 | 150 | 300 | 150 | C | 300 | 0.2 | 150 | 1 |
| 201 | Pine | 9999 | 3650 | 0 | 150 | 300 | 150 | D | 750 | 0.5 | 0 | 0 |
| 202 | Pine | 10029 | 3921 | 0 | 150 | 300 | 150 | D | 450 | 0.3 | 0 | 0 |
| 203 | Pine | 10044 | 4056 | 0 | 150 | 300 | 150 | D | 300 | 0.2 | 0 | 0 |
| 204 | Pine | 10059 | 4191 | 0 | 150 | 300 | 150 | D | 150 | 0.1 | 0 | 0 |
| 205 | Pine | 9924 | 3650 | 0 | 150 | 300 | 150 | D | 750 | 0.5 | 150 | 1 |
| 206 | Pine | 9954 | 3921 | 0 | 150 | 300 | 150 | D | 450 | 0.3 | 150 | 1 |
| 207 | Pine | 9969 | 4056 | 0 | 150 | 300 | 150 | D | 300 | 0.2 | 150 | 1 |
| 208 | Pine | 9984 | 4191 | 0 | 150 | 300 | 150 | D | 150 | 0.1 | 150 | 1 |
| 209 | Pine | 9887 | 3650 | 0 | 150 | 300 | 150 | D | 750 | 0.5 | 225 | 1.5 |
| 210 | Pine | 9933 | 4056 | 0 | 150 | 300 | 150 | D | 300 | 0.2 | 225 | 1.5 |
| 211 | Pine | 9963 | 4326 | 0 | 150 | 300 | 150 | none | 0 | 0 | 225 | 1.5 |
| 212 | Pine | 9850 | 3650 | 0 | 150 | 300 | 150 | D | 750 | 0.5 | 300 | 2 |
| 213 | Pine | 9880 | 3921 | 0 | 150 | 300 | 150 | D | 450 | 0.3 | 300 | 2 |
| 214 | Pine | 9895 | 4056 | 0 | 150 | 300 | 150 | D | 300 | 0.2 | 300 | 2 |
| 215 | Pine | 9910 | 4191 | 0 | 150 | 300 | 150 | D | 150 | 0.1 | 300 | 2 |
| 216 | Oak | 9999 | 3650 | 0 | 150 | 300 | 150 | D | 750 | 0.5 | 0 | 0 |
| 217 | Oak | 10029 | 3921 | 0 | 150 | 300 | 150 | D | 450 | 0.3 | 0 | 0 |
| 218 | Oak | 10044 | 4056 | 0 | 150 | 300 | 150 | D | 300 | 0.2 | 0 | 0 |
| 219 | Oak | 10059 | 4191 | 0 | 150 | 300 | 150 | D | 150 | 0.1 | 0 | 0 |
| 220 | Oak | 9924 | 3650 | 0 | 150 | 300 | 150 | D | 750 | 0.5 | 150 | 1 |
| 221 | Oak | 9954 | 3921 | 0 | 150 | 300 | 150 | D | 450 | 0.3 | 150 | 1 |
| 222 | Oak | 9969 | 4056 | 0 | 150 | 300 | 150 | D | 300 | 0.2 | 150 | 1 |
| 223 | Oak | 9984 | 4191 | 0 | 150 | 300 | 150 | D | 150 | 0.1 | 150 | 1 |
| 224 | Oak | 9887 | 3650 | 0 | 150 | 300 | 150 | D | 750 | 0.5 | 225 | 1.5 |
| 225 | Oak | 9933 | 4056 | 0 | 150 | 300 | 150 | D | 300 | 0.2 | 225 | 1.5 |
| 226 | Oak | 9963 | 4326 | 0 | 150 | 300 | 150 | none | 0 | 0 | 225 | 1.5 |
| 227 | Oak | 9850 | 3650 | 0 | 150 | 300 | 150 | D | 750 | 0.5 | 300 | 2 |
| 228 | Oak | 9880 | 3921 | 0 | 150 | 300 | 150 | D | 450 | 0.3 | 300 | 2 |
| 229 | Oak | 9895 | 4056 | 0 | 150 | 300 | 150 | D | 300 | 0.2 | 300 | 2 |
| 230 | Oak | 9910 | 4191 | 0 | 150 | 300 | 150 | D | 150 | 0.1 | 300 | 2 |
| 231 | Pine | 9928 | 3317 | 478 | 150 | 300 | 150 | D | 750 | 0.5 | 0 | 0 |
| 232 | Pine | 9973 | 3722 | 478 | 150 | 300 | 150 | D | 300 | 0.2 | 0 | 0 |
| 233 | Pine | 9816 | 3317 | 478 | 150 | 300 | 150 | D | 750 | 0.5 | 225 | 1.5 |
| 234 | Pine | 9861 | 3722 | 478 | 150 | 300 | 150 | D | 300 | 0.2 | 225 | 1.5 |
| 235 | Oak | 9928 | 3317 | 478 | 150 | 300 | 150 | D | 750 | 0.5 | 0 | 0 |
| 237 | Oak | 9816 | 3317 | 478 | 150 | 300 | 150 | D | 750 | 0.5 | 0 | 0 |
| 238 | Oak | 9861 | 3722 | 478 | 150 | 300 | 150 | D | 300 | 0.2 | 0 | 0 |
| 239 | Pine | 10030 | 3921 | 0 | 150 | 300 | 150 | E | 450 | 0.3 | 0 | 0 |
| 240 | Pine | 10045 | 4056 | 0 | 150 | 300 | 150 | E | 300 | 0.2 | 0 | 0 |
| 242 | Pine | 10060 | 4191 | 0 | 150 | 300 | 150 | E | 150 | 0.1 | 0 | 0 |
| 243 | Pine | 9985 | 4191 | 0 | 150 | 300 | 150 | E | 150 | 0.1 | 150 | 1 |
| 244 | Pine | 9910 | 4191 | 0 | 150 | 300 | 150 | E | 150 | 0.1 | 300 | 2 |
| 247 | Pine | 10044 | 4056 | 0 | 150 | 300 | 150 | F | 300 | 0.2 | 0 | 0 |
| 248 | Pine | 10059 | 4191 | 0 | 150 | 300 | 150 | F | 150 | 0.1 | 0 | 0 |
| 249 | Pine | 10068 | 4258 | 0 | 150 | 300 | 150 | F | 75 | 0.05 | 0 | 0 |
| 250 | Pine | 9984 | 4191 | 0 | 150 | 300 | 150 | F | 150 | 0.1 | 150 | 1 |
| 251 | Pine | 9993 | 4258 | 0 | 150 | 300 | 150 | F | 75 | 0.05 | 150 | 1 |
| 252 | Pine | 9918 | 4258 | 0 | 150 | 300 | 150 | F | 75 | 0.05 | 300 | 2 |
| 256 | Pine | 10000 | 4326 | 0 | 150 | 300 | 150 | none | 0 | 0 | 150** | 1** |
| 257 | Pine | 9925 | 4326 | 0 | 150 | 300 | 150 | none | 0 | 0 | 300** | 2** |
| 258 | Pine | 9969 | 4056 | 0 | 150 | 300 | 150 | D | 300 | 0.2 | 150** | 1** |
| 259 | Pine | 9895 | 4056 | 0 | 150 | 300 | 150 | D | 300 | 0.2 | 300** | 2** |

Pine Wood - Grade 2020 (American Wood Fibers Inc.)
Oak Wood - Grade 3720 (American Wood Fibers Inc.)
HDPE - Resin B-53 35H flakes (Solvay)
UV Stabilizer package - Tinuvin 770 (Ciba) 5 pbw, Tinuvin P (Ciba) 5 pbw, metal oxides pigments-15%, HDPE (carrier) - 75%
Masterbatch A - Masterbatch containing 10% 4.5 dichloro-2-n-octyl-4-isothiazolin-3-one in PE/VA/CO resin
Masterbatch B and F* - Masterbatch containing 10% active ingredient Pyrithione zinc
Masterbatch C - Masterbatch containing 10% active ingredient N-(triclhlormethylthio)-phthalimide in LDPE resin
Masterbatch D - Masterbatch containing 10% active ingredient Tetrachloroisophthalonitrile in HDPE resin
Masterbatch E - Masterbatch containing 10% 2-thiazol-4yl-1H-benzoimidazole
Zinc Borate - Borogard ZB ® (U.S. Borax)
Talc - Nicron 403 (Luzenac)
Zinc Stearate - (Ferro Chemicals)
EBS Wax - GE Specialty Chemicals)
“% ai” is percent active ingredient
*Different masterbatch suppliers
**= Boric Acid

### Example 2

Three 50×50×4 mm specimens were cut from the core of extruded boards, sterilized with a 30 kGy dose of Electron beam radiation and exposed to fungi attack according to ASTM G-21. For a more effective comparison of fungi growth, positive reference specimens were used such as Ponderosa Pine sapwood.

Fungi used in the experiment are listed in Table 2. After 28 days exposure to the fungi at 98% relative humidity and 28° C., specimens were evaluated using the first scale, from 0-4 as recommended by ASTM G-21 (see Table 3). Results are shown in Table 4 with the summary in Tables 5-7.

### Example 3

Samples prepared according to Example 1 were exposed to accelerated weathering using a QUV accelerated weathering chamber with fluorescent bulb combined with leaching cycle. Total exposure time was 500 hours. This includes cycles comprised of 8 h UV light (UVA 340 lamps @0.77 W/m²/nm) @60° C. followed by 4 hours condensation @50° C. Samples were exposed to these conditions for 15 hours and then leached in water. Leaching consisted of 4 hours soaking and 3 hours drip dry (1 hours was required for sample handling). Total exposure time was 500 hours. After exposure, three 1″×2.5″×⅛″ specimens were cut from the sample. The surface exposed to light and leaching and tested for fungi resistance as described in example 2. Results are presented in Table 3 with summary in Tables 4-6

### Example 4

Samples prepared according to Example 1 were exposed to accelerated weathering using a QUV accelerated weathering chamber with fluorescent bulb combined with leaching cycle. Total exposure time was 1000 hours. This includes cycles comprised of 8 h UV light (UVA 340 lamps @0.77 W/m²/nm) @60° C. followed by 4 hours condensation @50° C. Samples were exposed to these conditions for 16 hours and then leached in water. Leaching consisted of 4 hours soaking and 3 hours drip dry (1 h was required for sample handling). Total exposure time was 500 hours. After exposure, three 1″×2.5″×⅛″ specimens were cut from the sample. The surface exposed to light and leaching and tested for fungi resistance as described in Example 2. Results are presented in Table 3 with summary in Tables 4-6.

TABLE 2
Types of fungi and optimum media

| Fungi | ATCC No. | Optimum Medium |
|---|---|---|
| Aspergillus niger | 9642 | 360 potato dextrose agar |
| Penicillium pinophilum | 11797 | 360 potato dextrose agar |
| Chetomium globusum | 6202 | 329 mineral salt agar |
| Gliocladium virens | 9645 | 360 potato dextrose agar |
| Aurebasidium pullulans | 15233 | 28 Emmons modification of |
| | | Sabouraud agar |

TABLE 3
Growth assessment scale 0 to 4

| Observed growth on specimens | |
|---|---|
| Rating method | |
| (Sporulating and non sporulating, or both) | Rating Grade |
| None | 0 |
| Traces of growth (less than 10%) | 1 |
| Light growth (10 to 30%) | 2 |
| Medium growth (more than 30 to 60%) | 3 |
| Heavy growth (60% to complete coverage) | 4 |

TABLE 4a
Visual assessment of fungal growth on specimens
exposed to accelerated weathering

| | Fungal Growth-Assessment | | |
|---|---|---|---|
| Specimen | Weathering | | |
| Number | 0 hours | 500 hours | 1000 hours |
| 101 | 1 | 4 | 4 |
| 102 | 2 | 3 | 4 |
| 103 | 0 | 3 | 4 |
| 104 | 0 | 4 | 3 |
| 105 | 4 | 4 | 4 |
| 106 | 4 | 4 | 4 |
| 107 | 0 | 3 | 4 |
| 108 | 0 | 1 | 3 |
| 109 | 3 | 3 | 4 |
| 110 | 4 | 4 | 4 |
| 111 | 4 | 4 | 4 |
| 112 | 2 | 2 | 3 |
| 113 | 0 | 0 | 2 |
| 114 | 2 | 4 | 4 |
| 115 | 1 | 1 | 1 |
| 116 | 0 | 0 | 2 |
| 117 | 4 | 4 | 4 |
| 118 | 4 | 4 | 4 |
| 119 | 4 | 4 | 4 |
| 120 | 0 | NA | 4 |
| 121 | 0 | 2 | 4 |
| 122 | 0 | 4 | 4 |
| 123 | 0 | 3 | 2 |
| 124 | 1 | 4 | 4 |
| 125 | 0 | 2 | 4 |
| Specimen | Weathering | | |
| Number | 0 hours | 500 hours | 1000 hours |
| 126 | 0 | 3 | 4 |
| 127 | 0 | 2 | 3 |
| 128 | 4 | 4 | 4 |
| 129 | 0 | 2 | 2 |
| 130 | 0 | 0 | 1 |
| 131 | 1 | 3 | 3 |
| 132 | 0 | 2 | 2 |
| 133 | 0 | 2 | 2 |
| 134 | 4 | 4 | 3 |
| 135 | 2 | 3 | 3 |
| 136 | 4 | 3 | 4 |
| 137 | 3 | 3 | 4 |
| 138 | 1 | 1 | 2 |
| 139 | 4 | 4 | 4 |
| 140 | 2 | 4 | 4 |
| 141 | 3 | 2 | 3 |
| 142 | 1 | 3 | 3 |

TABLE 4b
Visual assessment of fungal growth on
specimens not exposed to weathering

| Specimen | |
|---|---|
| Number | 0 hours |
| 201 | 1 |
| 202 | 1 |
| 203 | 2 |
| 204 | 4 |
| 205 | 1 |
| 206 | 2 |
| 207 | 1 |
| 208 | 3 |
| 209 | 1 |
| 210 | 1 |
| 211 | 1 |
| 212 | 0 |
| 213 | 0 |
| 214 | 0 |
| 215 | 1 |
| 216 | 1 |
| 217 | 1 |
| 218 | 1 |
| 219 | 3 |
| 220 | 1 |
| 221 | 2 |
| 222 | 3 |
| 223 | 4 |
| 224 | 1 |
| 225 | 2 |
| 226 | 2 |
| 227 | 1 |
| 228 | 1 |
| 229 | 2 |
| 230 | 3 |
| 231 | 1 |
| 232 | 2 |
| 233 | 1 |
| 234 | 3 |
| 235 | 1 |
| 237 | 0 |
| 238 | 3 |
| 239 | 4 |
| 240 | 4 |
| 242 | 4 |
| 243 | 3 |
| 244 | 0 |
| 247 | 3 |
| 248 | 4 |
| 249 | 4 |
| 250 | 4 |
| 251 | 2 |
| 252 | 1 |
| 256 | 4 |
| 257 | 3 |
| 258 | 2 |
| 259 | 0 |

TABLE 5
Summary of visual assessment based on 0-4 fungal growth assessment scale for pine samples
without UV protective additives (WPC with pine wood without UV stabilizer package)

| | | Visual Assessment of Fungal Growth | | | | | | | | | | | |
|---|---|---|---|---|---|---|---|---|---|---|---|---|---|
| Cobiocides | | No Borates | | | ZB = 1% | | | ZB = 1.5% | ZB = 2% | | | BA = 1% | BA = 2% |
| | Content | Weathering | | | Weathering | | | Weathering | Weathering | | | Weathering | Weathering |
| Type | (%) | 0 h | 500 h | 1000 h | 0 h | 500 h | 1000 h | 0 hours | 0 h | 500 h | 1000 h | 0 hours | 0 hours |
| A | 0 | 4 | 4 | 4 | 2 | 4 | 4 | 1 | 0 | 4 | 3 | NA | NA |
| A | 0.03 | 4 | 4 | 4 | 2 | 4 | 4 | NA | 0 | 1 | 1 | NA | NA |
| A | 0.05 | 4 | 4 | 4 | 0 | 0 | 2 | NA | 0 | 0 | 2 | NA | NA |
| B | 0 | 4 | 4 | 4 | 2 | 4 | 4 | 1 | 0 | 4 | 3 | NA | NA |
| B | 0.05 | 4 | 4 | 4 | 0 | NA | 4 | NA | 0 | 2 | 4 | NA | NA |
| C | 0 | 4 | 4 | 4 | 2 | 4 | 4 | 1 | 0 | 4 | 3 | NA | NA |
| C | 0.1 | 4 | 4 | 4 | 1 | 3 | 3 | NA | 0 | 2 | 2 | NA | NA |
| C | 0.2 | 0 | 2 | 3 | 0 | 2 | 2 | NA | 0 | 0 | 1 | NA | NA |
| D | 0 | 4 | 4 | 4 | 2 | 4 | 4 | 1 | 0 | 4 | 3 | 4 | 3 |
| D | 0.2 | 2 | NA | NA | 1 | NA | NA | 1 | 0 | NA | NA | 2 | 0 |
| D | 0.5 | 1 | NA | NA | 1 | NA | NA | 1 | 0 | NA | NA | NA | NA |
| E | 0 | 4 | 4 | 4 | 2 | 4 | 4 | NA | 0 | 4 | 3 | NA | NA |
| E | 0.1 | 4 | NA | NA | 3 | NA | NA | NA | 0 | NA | NA | NA | NA |
| E | 0.3 | 4 | NA | NA | NA | NA | NA | NA | NA | NA | NA | NA | NA |
| F | 0 | 4 | 4 | 4 | 2 | 4 | 4 | NA | 0 | 4 | 4 | NA | NA |
| F | 0.05 | 4 | NA | NA | 2 | NA | NA | NA | 1 | NA | NA | NA | NA |
| F | 0.1 | 4 | NA | NA | 4 | NA | NA | NA | NA | NA | NA | NA | NA |

TABLE 6
Summary of visual assessment based on 0-4 fungal growth
assessment scale for pine samples with UV protective additives
(WPC with pine wood and UV stabilizer package)

| Cobiocides | | No Borates | | | ZB = 1% | | | ZB = 2% | | |
|---|---|---|---|---|---|---|---|---|---|---|
| | Content | Weathering | | | Weathering | | | Weathering | | |
| Type | (%) | 0 h | 500 h | 1000 h | 0 h | 500 h | 1000 h | 0 h | 500 h | 1000 h |
| A | 0 | 4 | 4 | 4 | 1 | 4 | 4 | 0 | 3 | 4 |
| A | 0.05 | NA | NA | NA | 0 | 0 | 2 | NA | NA | NA |
| B | 0 | 4 | 4 | 4 | 1 | 4 | 4 | 0 | 3 | 4 |
| B | 0.05 | NA | NA | NA | 1 | 4 | 4 | NA | NA | NA |
| C | 0 | 4 | 4 | 4 | 1 | 4 | 4 | 0 | 3 | 4 |
| C | 0.2 | NA | NA | NA | NA | NA | NA | 0 | 2 | 2 |
| D | 0 | 4 | 4 | 4 | 1 | 4 | 4 | 0 | 3 | 4 |
| D | 0.2 | 2 | NA | NA | NA | NA | NA | NA | NA | NA |
| D | 0.5 | 1 | NA | NA | NA | NA | NA | NA | NA | NA |

TABLE 7
Summary of visual assessment based on 0-4 fungal growth assessment scale for oak samples
without UV protective additives (WPC with oak wood and no UV stabilizer package)

| Cobiocides | | No Borates | | | ZB = 1% | | | ZB = 1.5% | ZB = 2% | | |
|---|---|---|---|---|---|---|---|---|---|---|---|
| | Content | Weathering | | | Weathering | | | Weathering | Weathering | | |
| Type | (%) | 0 h | 500 h | 1000 h | 0 h | 500 h | 1000 h | 0 h | 0 h | 500 h | 1000 h |
| A | 0 | 4 | 3 | 4 | 4 | 4 | 3 | 2 | 2 | 3 | 3 |
| A | 0.05 | 3 | 3 | 4 | 1 | 1 | 2 | NA | NA | NA | NA |
| B | 0 | 4 | 3 | 4 | 4 | 4 | 3 | 2 | 2 | 3 | 3 |
| B | 0.05 | 4 | 4 | 4 | 2 | 4 | 4 | NA | NA | NA | NA |
| C | 0 | 4 | 3 | 4 | 4 | 4 | 3 | 2 | 2 | 3 | 3 |
| C | 0.2 | 3 | 2 | 3 | 1 | 3 | 3 | NA | NA | NA | NA |
| D | 0 | 4 | 3 | 4 | 4 | 4 | 3 | 2 | 2 | 3 | 3 |
| D | 0.2 | 2 | NA | NA | 3 | NA | NA | 2 | 2 | NA | NA |
| D | 0.5 | 1 | NA | NA | 1 | NA | NA | 1 | 1 | NA | NA |

### Example 5

### Coating Film Preparation

Paint coatings were prepared using materials shown below according to the formulation listed in Table 8. Fungicidal additives: zinc borate and Chlortram were introduced into the coatings as listed in Table 8. The coatings were cast on flat polyethylene sheeting and dried into 10 mil thick film before removal from the polyethylene substrate.

Materials used are listed below:
Tamol® 850—dispersing aid supplied by Rohm & Haas
Kelzan® AR—thickener supplied by CP Kelco
Propylene Glycol—Dow Chemical
KTPP—potassium tripolyphosphate
BK 031—defoamer supplied by BYK Chemie
Titanium dioxide—Tronox® CR828 supplied by Kerr McGee Chemical LLC
Calcium carbonate—calcium carbonate 4HX supplied by Imasco Minerals
Acrylic latex—Rhoplex® EC 2218 supplied by Rhom & Haas
Texanol—coalescent solvent supplied by Eastman
Ammonium hydroxide—supplied by Aldrich
Predispersed colour concentrate—Aqua-Sperse C877-7214 Thalo blue supplied by Nuodex Colortrend Ltd.
Zinc borate—Borogard® ZB supplied by Rio Tinto Minerals—U.S. Borax Inc.
Chlortram—Chlortram 2,4,5,6 tetrachloro-1,3-benzene-dicarbonitrile (Chlorothalonil) fungicide (98% active ingredient) supplied by Sostram under the name Chlortram P-98

### Coating Film Exposure

The dried paint coatings were cut into 2″×2″ square specimens, sterilized with 30 kGy EB radiation and exposed to fungi attack according to ASTM G-21. Fungi used in the experiment are listed in Table 2. After 28 days exposure to the fungi at 98% relative humidity and 28° C., the specimens were evaluated using two scales. The first scale was from 0 to 4, as shown in Table 3. The second scale was from −10 to +10 which includes the creation of an inhibition zone around the specimen. Ratings from 0 to −10 indicate an increase in the inhibition zone and ratings from 0 to +10 indicate an increase in fungi growth. The results are presented in Table 8.

No fungal growth was observed only on specimens containing very high concentrations of Chlortram (0.33%), or co-biocidal compositions incorporated in coatings #041022-11 and #041022-14 containing only 0.07%-0.13% Chlortram in combination with zinc borate. The inhibition zone was found during evaluation of performance of coating #041022-14 which indicated a very strong biocidal effect. This was not detected for any other samples tested.

### Example 6

### Coating Film Preparation

Coatings were prepared using materials shown below according to the formulation listed in Tables 9 and 10. Zinc borate and organic algicide were introduced into the coatings as listed in Tables 9 and 10. The coatings were applied to clean concrete blocks and allowed to cure for 7 days at ambient temperature and a relative humidity of 40-60%.

Materials used are listed below:
Tamol® 850—dispersing aid supplied by Rohm & Haas
Kelzan® AR—thickener supplied by CP Kelco
Propylene Glycol—Dow Chemical
KTPP—potassium tripolyphosphate
BYK 031—defoamer supplied by BYK Chemie
Titanium dioxide—Tronox® CR828 supplied by Kerr McGee Chemical LLC
Calcium carbonate—calcium carbonate 4HX supplied by Imasco Minerals
   Acrylic latex—Rhoplex® EC 2218 supplied by Rhom & Haas
Texanol—coalescent solvent supplied by Eastman
Ammonium hydroxide—supplied by Aldrich
Zinc borate—Borogard® ZB supplied by Rio Tinto Minerals—U.S. Borax Inc.
Irgarol—organic algicide N′-tert-butyl-N-cyclopropyl-6-(methylthio)-1,3,5 triazine-2,4-diamine supplied by Ciba Specialty Chemicals under the trade name Irgarol® 1051

### Coating Film Exposure

The coated concrete blocks were exposed to exterior condition for a 3 month period from February to May in Vancouver, BC, Canada. The exposure area was known to be infested by green algae. After three months of exposure, many coating samples showed greenish discoloration, which was rated on a scale of 0-10, where 0 was no greenish discoloration and 10 was a heavy greenish growth on the surface. The results of the inspection are shown in Table 9.

Coatings containing a co-biocidal combination of organic algicide and zinc borate were found to be more resistant to algae growth in comparison to coatings containing only zinc borate or only organic algicide. For example, coating #060206-11 containing 1% zinc borate and 0.8% Irgarol algicide was rated 1 with almost no growth. The coatings containing only 1% zinc borate (#060206-2) or only 0.8% Irgarol (060206-7) were rated 3 and 4 respectively, indicating only moderate inhibition of algae growth.

TABLE 8
Coating formulations and assessment of fungal growth

| | Weight [g] | | | | | | | | | | | | | |
|---|---|---|---|---|---|---|---|---|---|---|---|---|---|---|
| | Formulation 041022 - | | | | | | | | | | | | | |
| Component | 1 | 2 | 3 | 4 | 5 | 6 | 7 | 8 | 9 | 10 | 11 | 12 | 13 | 14 |
| Water | 5.98 | 5.98 | 5.98 | 5.98 | 5.98 | 5.98 | 5.98 | 5.98 | 5.98 | 5.98 | 5.98 | 5.98 | 5.98 | 5.98 |
| Tamol ® 850 | 0.28 | 0.28 | 0.28 | 0.28 | 0.28 | 0.28 | 0.28 | 0.28 | 0.28 | 0.28 | 0.28 | 0.28 | 0.28 | 0.28 |
| Kelzan ® AR | 0.21 | 0.21 | 0.21 | 0.21 | 0.21 | 0.21 | 0.21 | 0.21 | 0.21 | 0.21 | 0.21 | 0.21 | 0.21 | 0.21 |
| Propylene | 1.93 | 1.93 | 1.93 | 1.93 | 1.93 | 1.93 | 1.93 | 1.93 | 1.93 | 1.93 | 1.93 | 1.93 | 1.93 | 1.93 |
| Glycol | | | | | | | | | | | | | | |
| KTPP | 0.08 | 0.08 | 0.08 | 0.08 | 0.08 | 0.08 | 0.08 | 0.08 | 0.08 | 0.08 | 0.08 | 0.08 | 0.08 | 0.08 |
| BYK 031 | 0.11 | 0.11 | 0.11 | 0.11 | 0.11 | 0.11 | 0.11 | 0.11 | 0.11 | 0.11 | 0.11 | 0.11 | 0.11 | 0.11 |
| Titanium | 2.12 | 2.12 | 2.12 | 2.12 | 2.12 | 2.12 | 2.12 | 2.12 | 2.12 | 2.12 | 2.12 | 2.12 | 2.12 | 2.12 |
| Dioxide | | | | | | | | | | | | | | |
| Calcium | 17.36 | 17.36 | 17.36 | 17.36 | 17.36 | 17.36 | 17.36 | 17.36 | 17.36 | 17.36 | 17.36 | 17.36 | 17.36 | 17.36 |
| Carbonate | | | | | | | | | | | | | | |
| Acrylic latex | 21.48 | 21.48 | 21.48 | 21.48 | 21.48 | 21.48 | 21.48 | 21.48 | 21.48 | 21.48 | 21.48 | 21.48 | 21.48 | 21.48 |
| Texanol | 0.42 | 0.42 | 0.42 | 0.42 | 0.42 | 0.42 | 0.42 | 0.42 | 0.42 | 0.42 | 0.42 | 0.42 | 0.42 | 0.42 |
| Ammonium | to | to | to | to | to | to | to | to | to | to | to | to | to | to |
| Hydroxide | pH 8 | pH 8 | pH 8 | pH 8 | pH 8 | pH 8 | pH 8 | pH 8 | pH 8 | pH 8 | pH 8 | pH 8 | pH 8 | pH 8 |
| Colourant | 0.1 | 0.1 | 0.1 | 0.1 | 0.1 | 0.1 | 0.1 | 0.1 | 0.1 | 0.1 | 0.1 | 0.1 | 0.1 | 0.1 |
| Zinc Borate | 0 | 0.334 | 0.677 | 1.025 | 0 | 0 | 0 | 0 | 0.335 | 0.676 | 1.025 | 0.335 | 0.677 | 1.025 |
| Chlortram | 0 | 0 | 0 | 0 | 0.033 | 0.0512 | 0.0663 | 0.1663 | 0.0335 | 0.0338 | 0.0341 | 0.0677 | 0.0678 | 0.0684 |
| Zinc Borate | 0% | 0.65% | 1.31% | 1.97% | 0% | 0% | 0% | 0% | 0.7% | 1.31% | 1.97% | 0.65% | 1.31% | 1.97% |
| Chlortram | 0% | 0% | 0% | 0% | 0.06% | 0.10% | 0.13% | 0.33% | 0.07% | 0.07% | 0.07% | 0.13% | 0.13% | 0.13% |
| Fungal growth | 1 | 2 | 1 | 1 | 1 | 1 | 0 | 0 | 1 | 1 | 0 | 1 | 1 | 0 |
| scale (0-4) | | | | | | | | | | | | | | |
| Fungal growth | +1 | +3 | +1 | +1 | +1 | +1 | 1 | 0 | +1 | +1 | 0 | +1 | +1 | −1 |
| scale (−10 to +10) | | | | | | | | | | | | | | |

TABLE 9
Coating formulation and assessment of algae growth

| | Weight [g] | | | | | | | | | | | | |
|---|---|---|---|---|---|---|---|---|---|---|---|---|---|
| | Formulation 060206 - | | | | | | | | | | | | |
| Component | R-1 | 1 | 2 | 3 | 4 | 5 | 6 | 7 | 8 | 9 | 10 | 11 | 12 |
| Water | 5.98 | 5.98 | 5.98 | 5.98 | 5.98 | 5.98 | 5.98 | 5.98 | 5.98 | 5.98 | 5.98 | 5.98 | 5.98 |
| Tamol ® 850 | 0.28 | 0.28 | 0.28 | 0.28 | 0.28 | 0.28 | 0.28 | 0.28 | 0.28 | 0.28 | 0.28 | 0.28 | 0.28 |
| Kelzan ® AR | 0.21 | 0.21 | 0.21 | 0.21 | 0.21 | 0.21 | 0.21 | 0.21 | 0.21 | 0.21 | 0.21 | 0.21 | 0.21 |
| Propylene | 1.93 | 1.93 | 1.93 | 1.93 | 1.93 | 1.93 | 1.93 | 1.93 | 1.93 | 1.93 | 1.93 | 1.93 | 1.93 |
| Glycol | | | | | | | | | | | | | |
| KTPP | 0.08 | 0.08 | 0.08 | 0.08 | 0.08 | 0.08 | 0.08 | 0.08 | 0.08 | 0.08 | 0.08 | 0.08 | 0.08 |
| BYK 031 | 0.11 | 0.11 | 0.11 | 0.11 | 0.11 | 0.11 | 0.11 | 0.11 | 0.11 | 0.11 | 0.11 | 0.11 | 0.11 |
| Titanium | 2.12 | 2.12 | 2.12 | 2.12 | 2.12 | 2.12 | 2.12 | 2.12 | 2.12 | 2.12 | 2.12 | 2.12 | 2.12 |
| Dioxide | | | | | | | | | | | | | |
| Calcium | 17.36 | 17.36 | 17.36 | 17.36 | 17.36 | 17.36 | 17.36 | 17.36 | 17.36 | 17.36 | 17.36 | 17.36 | 17.36 |
| Carbonate | | | | | | | | | | | | | |
| Acrylic latex | 21.48 | 21.48 | 21.48 | 21.48 | 21.48 | 21.48 | 21.48 | 21.48 | 21.48 | 21.48 | 21.48 | 21.48 | 21.48 |
| Texanol | 0.42 | 0.42 | 0.42 | 0.42 | 0.42 | 0.42 | 0.42 | 0.42 | 0.42 | 0.42 | 0.42 | 0.42 | 0.42 |
| Ammonium | to | to | to | to | to | to | to | to | to | to | to | to | to |
| Hydroxide | pH 8 | pH 8 | pH 8 | pH 8 | pH 8 | pH 8 | pH 8 | pH 8 | pH 8 | pH 8 | pH 8 | pH 8 | pH 8 |
| Zinc Borate | 0 | 1.00 | 0.50 | 0.35 | 0.25 | 0.125 | 0 | 0 | 0 | 0 | 0 | 0.5 | 0.5 |
| Irgarol | 0 | 0 | 0 | 0 | 0 | 0 | 0.60 | 0.40 | 0.20 | 0.10 | 0.05 | 0.40 | 0.20 |
| Zinc Borate | 0% | 2% | 1% | 0.7% | 0.5% | 0.25% | 0% | 0% | 0% | 0% | 0% | 1.0% | 1.0% |
| Irgarol | 0% | 0% | 0% | 0% | 0% | 0% | 1.2% | 0.8% | 0.4% | 0.2% | 0.1% | 0.8% | 0.4% |
| Algae growth | 6 | 2 | 3 | 5 | 5 | 5 | 3 | 4 | 5 | 5 | 7 | 1 | 2 |
| scale (1-10) | | | | | | | | | | | | | |

TABLE 10
Coating formulation and assessment of algae growth

| | Weight [g] | | | | | | | | | | |
|---|---|---|---|---|---|---|---|---|---|---|---|
| | Formulation 060206 - | | | | | | | | | | |
| Component | R-2 | 13 | 14 | 15 | 16 | 17 | 18 | 19 | 20 | 21 | 22 |
| Water | 5.98 | 5.98 | 5.98 | 5.98 | 5.98 | 5.98 | 5.98 | 5.98 | 5.98 | 5.98 | 5.98 |
| Tamol ® 850 | 0.28 | 0.28 | 0.28 | 0.28 | 0.28 | 0.28 | 0.28 | 0.28 | 0.28 | 0.28 | 0.28 |
| Kelzan ® AR | 0.21 | 0.21 | 0.21 | 0.21 | 0.21 | 0.21 | 0.21 | 0.21 | 0.21 | 0.21 | 0.21 |
| Propylene | 1.93 | 1.93 | 1.93 | 1.93 | 1.93 | 1.93 | 1.93 | 1.93 | 1.93 | 1.93 | 1.93 |
| Glycol | | | | | | | | | | | |
| KTPP | 0.08 | 0.08 | 0.08 | 0.08 | 0.08 | 0.08 | 0.08 | 0.08 | 0.08 | 0.08 | 0.08 |
| BYK 031 | 0.11 | 0.11 | 0.11 | 0.11 | 0.11 | 0.11 | 0.11 | 0.11 | 0.11 | 0.11 | 0.11 |
| Titanium | 2.12 | 2.12 | 2.12 | 2.12 | 2.12 | 2.12 | 2.12 | 2.12 | 2.12 | 2.12 | 2.12 |
| Dioxide | | | | | | | | | | | |
| Calcium | 17.36 | 17.36 | 17.36 | 17.36 | 17.36 | 17.36 | 17.36 | 17.36 | 17.36 | 17.36 | 17.36 |
| Carbonate | | | | | | | | | | | |
| Acrylic latex | 21.48 | 21.48 | 21.48 | 21.48 | 21.48 | 21.48 | 21.48 | 21.48 | 21.48 | 21.48 | 21.48 |
| Texanol | 0.42 | 0.42 | 0.42 | 0.42 | 0.42 | 0.42 | 0.42 | 0.42 | 0.42 | 0.42 | 0.42 |
| Ammonium | to | to | to | to | to | to | to | to | to | to | to |
| Hydroxide | pH 8 | pH 8 | pH 8 | pH 8 | pH 8 | pH 8 | pH 8 | pH 8 | pH 8 | pH 8 | pH 8 |
| Zinc Borate | 0 | 0.50 | 0.50 | 0.25 | 0.25 | 0.25 | 0.25 | 0.13 | 0.13 | 0.13 | 0.13 |
| Irgarol | 0 | 0.1 | 0.05 | 0.40 | 0.20 | 0.10 | 0.05 | 0.40 | 0.20 | 0.10 | 0.05 |
| Zinc Borate | 0% | 1.00% | 1.00% | 0.50% | 0.50% | 0.50% | 0.50% | 0.25% | 0.25% | 0.25% | 0.25% |
| Irgarol | 0% | 0.20% | 0.10% | 0.80% | 0.40% | 0.20% | 0.10% | 0.80% | 0.40% | 0.20% | 0.10% |
| Algae growth | 6 | 3 | 3 | 3 | 5 | 5 | 4 | 5 | 6 | 7 | 6 |
| scale (1-10) | | | | | | | | | | | |

What is claimed is:

1. A method for protecting a polymeric material against microbial attack, wherein the polymeric material is comprised of at least one continuous phase man-made polymer and at least one biodegradable component, and wherein the method comprises incorporating into the polymeric material at least one boron-containing compound and at least one organic biocide, thereby producing a treated polymeric material.

2. The method according to claim 1 wherein the boron-containing compound comprises boric oxide, boric acid, salts of boric acid, or mixtures thereof.

3. The method according to claim 1 wherein the boron-containing compound is zinc borate.

4. The method according to claim 1 wherein the boron-containing compound comprises between about 0.2% and about 5% by weight of the treated polymeric material.

5. The method according to claim 1 wherein the boron-containing compound comprises between about 0.5 and about 3% by weight of the treated polymeric material.

6. The method according to claim 1 wherein the organic biocide is an organic fungicide.

7. The method according to claim 6 wherein the organic fungicide comprises 4.5 dichloro-2-n-octyl-4-isothiazolin-3-one, N-(trichlormethylthio)-phthalimide, pyrithione zinc, tetrachloroiso-phthalonitrile, or mixtures thereof.

8. The method according to claim 6 wherein the organic fungicide comprises from about 0.005% to about 2% by weight of the treated polymeric material.

9. The method according to claim 6 wherein the organic fungicide comprises from about 0.02% to about 1% by weight of the treated polymeric material.

10. The method according to claim 6 wherein the organic fungicide comprises from about 0.05% to about 0.5% by weight of the treated polymeric material.

11. The method according to claim 1 wherein the organic biocide is an organic algicide or organic bactericide.

12. The method according to claim 1 wherein the man-made polymer is thermoplastic resin, and wherein the boron-containing compound and organic fungicide are mixed with thermoplastic resin and biodegradable component and the treated polymeric material is extruded to produce a shaped article.

13. A treated polymeric material comprising a continuous phase man-made polymer, a biodegradable component, a boron-containing compound and an organic biocide.

14. The treated polymeric material according to claim 13 wherein the boron-containing compound comprises boric oxide, boric acid, salts of boric acid, or combinations thereof.

15. The treated polymeric material according to claim 13 wherein the boron-containing compound is zinc borate.

16. The treated polymeric material according to claim 13 wherein the boron-containing compound comprises between about 0.2% and about 5% by weight of the treated polymeric material.

17. The treated polymeric material according to claim 13 wherein the boron-containing compound comprises between about 0.5 and about 3% by weight of the treated polymeric material.

18. The treated polymeric material according to claim 13 wherein the organic biocide is an organic fungicide.

19. The treated polymeric material according to claim 18 wherein the organic fungicide comprises 4.5 dichloro-2-n-octyl-4-isothiazolin-3-one, N-(trichlormethylthio)-phthalimide, pyrithione zinc, tetrachloroiso-phthalonitrile, or mixtures thereof.

20. The treated polymeric material according to claim 18 wherein the organic fungicide comprises from about 0.005% to about 2% by weight of the treated polymeric material.

21. The treated polymeric material according to claim 18 wherein the organic fungicide comprises from about 0.02% to about 1% by weight of the treated polymeric material.

22. The treated polymeric material according to claim 18 wherein the organic fungicide comprises from about 0.05% to about 0.5% by weight of the treated polymeric material.

23. The treated polymeric material according to claim 13 wherein the organic biocide is an organic algicide or organic bactericide.

24. The treated polymeric material according to claim 13 wherein the man-made polymer comprises polyolefins, polyvinylchloride, polyurethanes, polyesters, acrylics, polyvinyl acetate, styrenic polymers, polydienes, or combinations thereof.

25. The treated polymeric material according to claim 13 wherein the man-made polymer is a polyolefin selected from the group consisting of polyethylene, polypropylene, copolymers containing ethylene or propylene units and blends thereof.

26. The treated polymeric material according to claim 13 wherein the biodegradable component comprises wood, bark, fatty oils or modified fatty oils, polysaccharides or modified polysaccharide derivatives, aliphatic polyester, fatty acids and their derivatives, chitin or chitosin and their derivatives, or combinations thereof.

27. The treated polymeric material according to claim 13 wherein the biodegradable component is a natural product, a modified natural product, a synthetic biodegradable material, or combinations thereof.

28. A shaped article comprising a continuous phase man-made thermoplastic resin polymer, a biodegradable component, a boron-containing compound and an organic biocide.
